(19) United States
(12) Patent Application Publication
(10) Pub. No.: US 2009/0126252 A1
(43) Pub. Date: May 21, 2009

(54) ESTRUS SCENT ARTICLE AND PROCESS OF MAKING

(76) Inventor: Ricky James Lowe, Landisburg, PA (US)

Correspondence Address: WOOD AND EISENBERG, PLLC, 6911 RICHMOND HIGHWAY, SUITE 403, Alexandria, VA, 22306, US

(21) Appl. No.: 12/271,039

(22) Filed: Nov. 14, 2008

Related U.S. Application Data
(60) Provisional application No. 60/988,763, filed on Nov. 16, 2007.

(51) Int. Cl. A01M 31/00; A01N 63/02; B65D 85/00

(52) U.S. Cl. 43/1; 424/84; 206/223

(57) ABSTRACT

In one aspect of the invention a process is provided for producing deer scented estrus articles comprising the steps: using at least one cotton-swab to collect vaginal fluids from the vaginal canal of a female deer in estrus such that vaginal fluids are collected on one or both ends of the at least one cotton swab; placing at least one cotton swab with vaginal fluid collected thereon into a bottle; and collecting urine from at least one female deer producing estrus secretions in their urine, and placing at least a portion of the collected urine in to the bottle to provide at least one bottle containing deer urine with estrus secretions in the deer urine and at least one cotton swab with vaginal fluid deposited thereon at least partly immersed in the urine.

### CROSS-REFERENCE TO RELATED APPLICATIONS

This application claims the benefit of priority from U.S. Provisional Patent Application Ser. No. 60/988,763, filed Nov. 16, 2007, the entire contents of which are incorporated herein by reference.

### STATEMENT REGARDING FEDERALLY SPONSORED RESEARCH OR DEVELOPMENT

Not Applicable.

### FIELD OF THE INVENTION

This invention relates generally to collecting, selling and using fresh estrus scent collected from adult female deer (i.e., does), wherein the estrus scent has a functional use as a buck lure for use by, e.g., deer hunters, photographers and other wildlife enthusiasts to lure adult male deer.

### BACKGROUND OF THE INVENTION

As noted in U.S. Pat. No. 4,944,940, hunting wild animals, and especially deer, is an art requiring the proper mix of intelligence, patience, endurance and the right equipment. Because deer rely heavily on their highly developed sense of smell to alert them to a multitude of factors, such as danger, food, and the presence of other animals, it is necessary for the hunter to blend into the environment, without alerting the deer to his presence. It is also very helpful to provide some means to attract the animal to the hunter's vicinity.

With respect to deer, and especially the male of the species or the buck, a buck lure is often used to tempt the buck. Buck lures have application not only for deer hunters, but also for photographers and other wildlife enthusiasts.

The ideal time for hunting bucks, and especially the mature or dominant bucks, is during the time that does are in heat or estrus and are sexually receptive. During this time, bucks tend to become very predictable in their pattern of activity. The mating season puts bucks in a state of sexual excitement called a “rut”. During rut season, a buck will mark off his “breeding territory”. The buck will then attempt to prevent other bucks from entering his breeding territory, and will herd up the available does in heat for breeding.

There remains a need for more efficient ways for deer hunters, photographers and other wildlife enthusiasts to lure adult male deer, i.e., to lure bucks in rut to an area of interest for the purposes of hunting, photographing or observation.

### SUMMARY

A deer scented estrus article and process for providing the deer scented estrus article for use by deer hunters for hunting any kind of deer. In one aspect of the invention a process for producing deer scented estrus articles, which comprises: using at least one cotton-swab to collect vaginal fluids from the vaginal canal of a female deer in estrus such that vaginal fluids are collected on one or both ends of the at least one cotton swab; placing at least one cotton swab with vaginal fluid collected thereon into a bottle; and collecting urine from at least one female deer producing estrus secretions in their urine, and placing at least a portion of the collected urine in to the bottle to provide at least one bottle containing deer urine with estrus secretions in the deer urine and at least one cotton swab with vaginal fluid deposited thereon at least partly immersed in the urine.

### BRIEF DESCRIPTION OF THE DRAWINGS

FIG. 1 shows a cotton swab with at least one cotton wad end with estrus collected thereon according to the present invention.

FIG. 2 shows a bottle filled with urine collected from a female doe in estrus, and at least one estrus containing cotton swab in the urine according to the present invention.

FIG. 3 shows the bottle of FIG. 2, but with a label thereon, the label comprising indicia describing the contents thereof according to the present invention.

### DETAILED DESCRIPTION OF THE INVENTION

A method for collecting, selling and using estrus scent from adult female deer (i.e., does). It should be understood that in the context of this paper the term “estrus scent” is used to refer to vaginal fluids collected on swabs in accordance with the present invention from an adult deer at or close to the peak of its estrus cycle such that the collected vaginal fluids contain estrus scent recognizable by an adult male deer in rut. Therefore, for the purposes of this paper, the terms “estrus scent”, “doe scent” and “vaginal fluids containing estrus scent” are regarded as equivalent terms. The term “female deer in estrus” refers to a female deer that is producing secretions of estrus in their vaginal fluid. The female deer is estrus can be any species of deer such as, but expressly not limited to, the white-tailed variety, i.e., a white-tailed female deer in estrus. Other examples of deer from which estrus in urine and/or vaginal fluids can be collected from include, but are not limited to: Sika deer, Mule deer, Red deer, Brocket deer (e.g., Red Brocket), Pudus, Muntjacs deer (e.g., Reeve's Muntjac and Indian Muntjac deer), Roe Deer, Fallow Deer, Moose, Thorold's deer, Central Asian Red Deer, Sambar Deer, Hog Deer, Rusa deer, Chital and Elk.

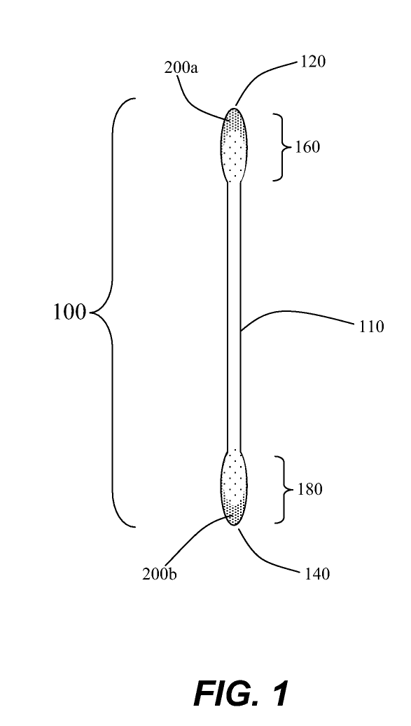

Doe scent is deposited on sticks, such as cotton swabs with a wad of cotton wrapped around either one or both ends of a middle section in the shape of a rod, usually made of either wood, rolled paper, or plastic (e.g., Q-tips®). The doe scent is collected on at least one cotton swab from the vaginal canal of does in heat, i.e., secreting estrus in their vaginal fluids. Vaginal fluid containing estrus scent is collected by first sedating an adult doe (such as a whitetail deer doe), wherein the adult doe is close to the peak of her estrus cycle. The sedated doe is positioned at a convenient upright angle (e.g., at about 30° to 50°, with an upright angle of about 45° being the preferred upright angle (see FIG. 1) to allow fresh secreted fluids containing estrus scent to flow easily toward the doe's vaginal canal. A Q-tip (or a functionally equivalent apparatus) is inserted into the vaginal canal to collect estrus-containing fluid by swabbing the vaginal canal and/or area proximate to the adult doe's vaginal canal. One or more Q-tips are used to swab up estrus containing fluid. The Q-tips with estrus containing fluid deposited thereon (“estrus coated Q-tips”) are collected in a container; the container can take any suitable form such as a bottle.

In one embodiment of the invention, the Q-tips have a coating containing preservative deposited thereon, wherein the preservative-coated Q-tips are inserted into a doe's vaginal canal to deposit the estrus containing fluid thereon. The preservative can be any suitable preservative that extends the shelf life of the estrus containing fluid deposited on the Q-tips. In one embodiment, the preservative is selected from the group consisting of: alcohol, glycerin, propylene, glycol, and mineral oil, alone or in combination. In the alternative, the Q-tips are not coated with a preservative and are otherwise maintained free of preservative.

In another embodiment of the invention, customers are shown the Q-tips with estrus containing fluid thereon, wherein the customer receives a visual cue or satisfaction that he/she is buying a genuine estrus-containing article of manufacture.

In one aspect of the invention a process is proved for producing deer scented estrus articles, the process comprises:
(a) identifying a female deer producing vaginal fluid containing estrus secretion;
(b) collecting urine from at least one female deer producing estrus secretions in their urine, and placing at least a portion of the collected urine in at least one bottle to provide at least one bottle containing deer urine with estrus secretions in the deer urine;
(c) sedating the female deer;
(d) using at least one cotton-swab to collect vaginal fluids from the vaginal canal of the female deer such that vaginal fluids are collected on one or both ends of the at least one cotton swab;
(e) repeating step (d) until a desired amount of vaginal fluid has been collected onto cotton swabs; and
(f) placing at least one cotton swab with vaginal fluid collected thereon into the bottle containing urine,
whereby vaginal fluid collected on cotton swabs and placed in bottles containing collected urine provides additional estrus for use by deer hunters,
wherein step (b) is optionally carried out between steps (c) and (f), and
wherein urine collected in step (b) is collected from the female deer identified in step (a) and in the alternative the urine collected in step (b) is collected from a different female deer than the female deer identified in step (a).

The present invention also provides a deer scented article in the form of a bottle containing urine with female deer estrus therein and at least one cotton swab with at least one end thereof defining a wad of cotton with female deer vaginal fluid deposited thereon and immersed in the urine.

In a further aspect of the invention the step of sedating the female deer further comprises the step of elevating the sedated female deer such that the body of the sedated female deer is held at a predetermined angle with respect to the horizontal plane for a predetermined period of time before performing steps (d) and (e) listed above. The deer is elevated such that the rear end of the female deer in estrus is facing downwards and closest to the ground.

In one embodiment, the body of the sedated female deer is elevated between 10° and 50° with respect to the horizontal plane. Alternatively, the sedated female deer is held at between 10° and 60° with respect to the horizontal plane for between 5 and 90 minutes before performing steps (d) and (e). In one embodiment, the body of the sedated female deer is held at between 35° and 50° with respect to the horizontal plane for between 30 and 60 minutes before performing steps (d) and (e). Alternatively, the body of the sedated female deer is held at a 45° slope with respect to the horizontal plane for 60 minutes before performing steps (d) and (e).

The inventor has made the unexpected discovery that placing the sedated female deer angled downwards on a slope enables easier access to the vaginal fluids. More specifically, the inventor has discovered that there is no need to use vacuum equipment such as a laparoscopic vacuum apparatus to extract vaginal contents from female deer. After allowing the sedated female doe to rest on the slope, a human operator can collect vaginal fluids containing estrus by dabbing with cotton swabs about 2 inches inside the vaginal canal. For example, it has been found that a human operator can obtain between 30 to 100 cotton swabs dabbed in vaginal fluid from a doe sedated and rested for around 60 minutes at a slope angle of 45°.

In one aspect of the invention a container is provided, wherein the contents of the container comprises: deer urine, the deer urine collected from a female deer in estrus; and at least one cotton swab with at least one end defining a wad of cotton, the cotton with vaginal fluid contained therein, the vaginal fluid having been previously collected from a female deer with estrus in its vaginal fluid, wherein the cotton swab is at least partly immersed in the urine.

In one embodiment, the container is a bottle with doe urine therein and at least one cotton swab (previously been dabbed with vaginal fluid) either fully or at least partly immersed in the urine. The bottle can be any suitable size or shape. In one embodiment the bottle is transparent to the extent that a purchaser can see at least one estrus containing cotton swab inside the bottle immersed in urine collected from a female deer in estrus.

In a further aspect of the invention the step of sedating the female deer further comprises the step of:
(a) identifying a female deer producing vaginal fluid containing estrus secretion;
(c) sedating the female deer;
(d) using at least one cotton-swab to collect vaginal fluids from the vaginal canal of the female deer such that vaginal fluids are collected on one or both ends of the at least one cotton swab;
(e) repeating step (d) until a desired amount of vaginal fluid has been collected onto cotton swabs;
(f) placing at least one cotton swab with vaginal fluid collected thereon into a bottle; and
(g) collecting urine from at least one female deer producing estrus secretions in their urine, and placing at least a portion of the collected urine in to the bottle to provide at least one bottle containing deer urine with estrus secretions in the deer urine and at least one cotton swab with vaginal fluid deposited thereon at least partly immersed in the urine,
whereby vaginal fluid collected on cotton swabs in bottles containing collected urine provides additional estrus for use by deer hunters.

In one aspect of the invention a process for producing deer scented estrus articles, which comprises: using at least one cotton-swab to collect vaginal fluids from the vaginal canal of a female deer in estrus such that vaginal fluids are collected on one or both ends of the at least one cotton swab; placing at least one cotton swab with vaginal fluid collected thereon into a bottle; and collecting urine from at least one female deer producing estrus secretions in their urine, and placing at least a portion of the collected urine in to the bottle to provide at least one bottle containing deer urine with estrus secretions in the deer urine and at least one cotton swab with vaginal fluid deposited thereon at least partly immersed in the urine.

Referring to FIG. 1, which shows a cotton swab 100 comprising a middle section with the appearance of a rod 110 with first and second opposite ends 120 and 140 respectively defining first and second cotton wads 160 and 180, where the cotton wad on one or both ends has been previously used to collect vaginal fluid containing estrus 200 (represented in FIG. 1 using alpha-numeric labels “200a” and “200b”) from a female deer in estrus.

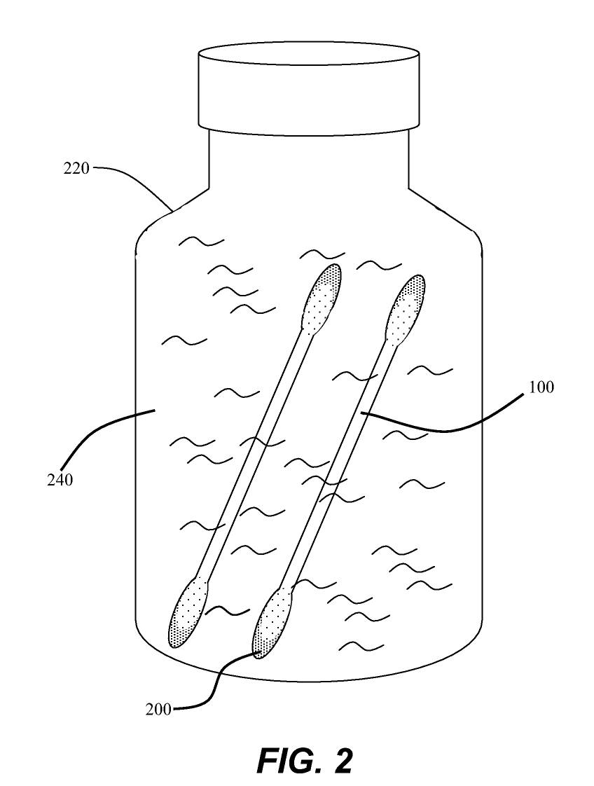

FIG. 2 shows a bottle 220 filled with urine 240 collected from a female doe in estrus, and at least one estrus containing cotton swab 100 immersed in the urine 240.

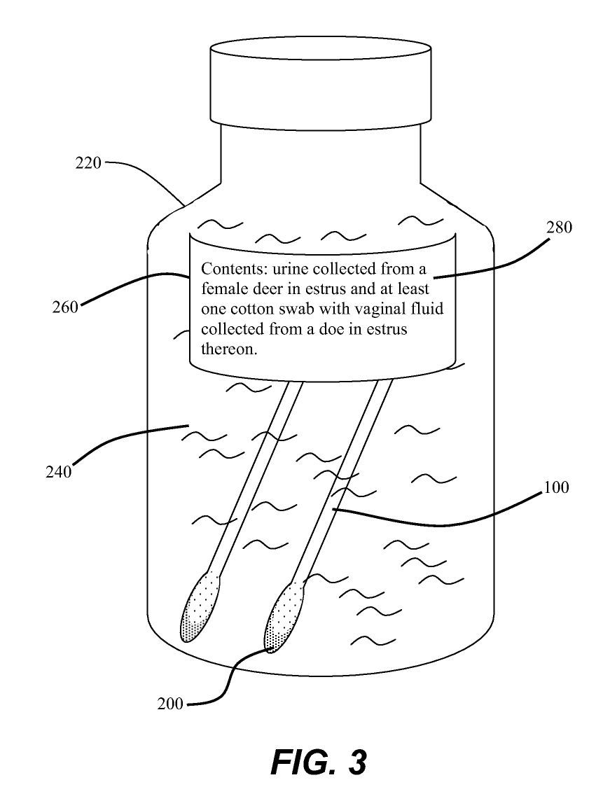

FIG. 3 shows the bottle of FIG. 2, but with a label 260 thereon, the label 260 comprising indicia 280 describing the contents thereof according to the present invention.

It is to be understood that the present invention is not limited to the embodiments described above or as shown in the attached figures, but encompasses any and all embodiments within the spirit of the invention.

I claim:

1. A process for producing deer scented estrus articles, which comprises:
(a) identifying a female deer producing vaginal fluid containing estrus secretion;
(b) collecting urine from at least one female deer producing estrus secretions in their urine, and placing at least a portion of said collected urine in at least one bottle to provide at least one bottle containing deer urine with estrus secretions in the deer urine;
(c) sedating said female deer;
(d) using at least one cotton-swab to collect vaginal fluids from the vaginal canal of said female deer such that vaginal fluids are collected on one or both ends of said at least one cotton swab;
(e) repeating step (d) until a desired amount of vaginal fluid has been collected onto cotton swabs; and
(f) placing at least one cotton swab with vaginal fluid collected thereon into said bottle containing urine,
whereby vaginal fluid collected on cotton swabs and placed in bottles containing collected urine provides additional estrus for use by deer hunters.

2. The process for producing deer scented articles according to claim 1, wherein the deer scented article is a bottle containing urine with estrus secretions therein and one cotton swab with at least one end defining a wad of cotton with vaginal fluid containing estrus deposited on said wad of cotton, wherein the wad of cotton is immersed in said urine.

3. The process for producing deer scented articles according to claim 1, wherein step (b) is carried out between steps (c) and (f).

4. The process for producing deer scented articles according to claim 1, wherein urine collected in step (b) is collected from the female deer identified in step (a).

5. The process for producing deer scented articles according to claim 1, wherein urine collected in step (b) is collected from a different female deer than the female deer identified in step (a).

6. The process for producing deer scented articles according to claim 1, wherein step of sedating said female deer further comprises the step of elevating said sedated female deer such that the body of said sedated female deer is elevated between 100 and 500 with respect to the horizontal plane.

7. The process for producing deer scented articles according to claim 1, wherein the step of sedating said female deer further comprises the step of elevating said sedated female deer such that the body of said sedated female deer is held at a predetermined angle with respect to the horizontal plane for a predetermined period of time before performing steps (d) and (e).

8. The process for producing deer scented articles according to claim 1, wherein the step of sedating said female deer further comprises the step of elevating said sedated female deer such that the body of said sedated female deer is held at between 100 and 600 with respect to the horizontal plane for between 5 and 90 minutes before performing steps (d) and (e).

9. The process for producing deer scented articles according to claim 1, wherein the step of sedating said female deer further comprises the step of elevating said sedated female deer such that the body of said sedated female deer is held at between 35° and 50° with respect to the horizontal plane for between 30 and 60 minutes before performing steps (d) and (e).

10. The process for producing deer scented articles according to claim 1, wherein the step of sedating said female deer further comprises the step of elevating said sedated female deer such that the body of said sedated female deer is held at a 45° slope with respect to the horizontal plane for 60 minutes before performing steps (d) and (e).

11. The process for producing deer scented articles according to claim 1, wherein step (d) involves collecting vaginal fluid from about two inches inside the vaginal canal of the female deer.

12. A container for use by deer hunters, the contents of said container comprising:
deer urine, said deer urine collected from a female deer in estrus; and
at least one cotton swab with at least one end defining a wad of cotton, said cotton with vaginal fluid contained therein, said vaginal fluid having been previously collected from a female deer with estrus in its vaginal fluid,
wherein said cotton swab is at least partly immersed in said urine.

13. A process for producing deer scented estrus articles, which comprises:
using at least one cotton-swab to collect vaginal fluids from the vaginal canal of a female deer in estrus such that vaginal fluids are collected on one or both ends of said at least one cotton swab;
placing at least one cotton swab with vaginal fluid collected thereon into a bottle; and
collecting urine from at least one female deer producing estrus secretions in their urine, and placing at least a portion of said collected urine in to said bottle to provide at least one bottle containing deer urine with estrus secretions in the deer urine and at least one cotton swab with vaginal fluid deposited thereon at least partly immersed in said urine.
